(19) United States
(12) Patent Application Publication
(10) Pub. No.: US 2026/0129589 A1
(43) Pub. Date: May 7, 2026

(54) ELECTRONIC DEVICE AND METHOD FOR OPERATING ACCESS POINT

(71) Applicant: Samsung Electronics Co., Ltd., Suwon-si (KR)

(72) Inventor: Junsu CHOI, Suwon-si (KR)

(21) Appl. No.: 19/437,854

(22) Filed: Dec. 31, 2025

Related U.S. Application Data
(63) Continuation of application No. PCT/KR2024/006446, filed on May 13, 2024.

(30) Foreign Application Priority Data
Jul. 7, 2023 (KR) 10-2023-0088558
Jul. 21, 2023 (KR) 10-2023-0095609

(51) Int. Cl. H04W 52/36; H04W 52/02; H04W 52/22

(52) U.S. Cl. CPC H04W 52/365; H04W 52/0245; H04W 52/225; H04W 52/367

(57) ABSTRACT

An electronic device is provided. The electronic device includes at least one wireless communication module configured to transmit and receive a wireless signal, at least one processor operatively connected to the wireless communication module, and memory storing instructions, wherein the instructions, when executed individually or collectively by the at least one processor, cause the electronic device to transmit, to an external electronic device, a frame comprising an uplink power headroom (UPH) control field, receive a trigger frame for uplink multi-user communication from the external electronic device, and perform communication with the external electronic device based on information comprised in the trigger frame, wherein the UPH control field indicates information about maximum power that the electronic device is capable of utilizing for communication, and wherein the information is determined based on a time average specific absorption rate (TAS) backoff policy.

### CROSS-REFERENCE TO RELATED APPLICATION(S)

This application is a continuation application, claiming priority under 35 U.S.C. § 365 (c), of an International application No. PCT/KR2024/006446, filed on May 13, 2024, which is based on and claims the benefit of a Korean patent application number 10-2023-0088558, filed on Jul. 7, 2023, in the Korean Intellectual Property Office, and of a Korean patent application number 10-2023-0095609, filed on Jul. 21, 2023, in the Korean Intellectual Property Office, the disclosure of each of which is incorporated by reference herein in its entirety.

### BACKGROUND

### 1. Field

The disclosure relates to an electronic device and an operating method of an access point (AP).

### 2. Description of Related Art

With the advent of electronic devices such as a smartphone, a tablet personal computer (PC), or a laptop, the demand for high-speed wireless connectivity has exploded. These trends and the growing demand for high-speed wireless connectivity have firmly established the Institute of Electrical and Electronic Engineers (IEEE) 802.11 wireless communication standard as a representative and universal high-speed wireless communication standard in the information technology (IT) industry. Early wireless local area network (WLAN) technologies developed around 1997 could support transmission speeds of up to 1 to 2 megabits per second (Mbps). Since then, based on the demand for faster wireless connectivity, WLAN technologies have steadily developed, including new WLAN technologies that improve transmission speeds, such as IEEE 802.11n, 802.11ac, and 802.11ax. The current IEEE 802.11 ax has a maximum transmission speed of several gigabits per second (Gbps).

Today, WLANs provide high-speed wireless connections to users in various public places such as offices, airports, stadiums, and stations, in addition to private places such as homes. Accordingly, WLAN has greatly influenced people's lifestyles and culture and has become a lifestyle in modern life.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide to an electronic device and an operating method of an access point (AP).

Additional aspects will be set forth in part in the description which follows and, in part, will be apparent from the description, or may be learned by practice of the presented embodiments.

In accordance with an aspect of the disclosure, an electronic device is provided. The electronic device includes at least one wireless communication module configured to transmit and receive a wireless signal, at least one processor operatively connected to the wireless communication module, and memory storing instructions, wherein the instructions, when executed by the at least one processor individually or collectively, cause the electronic device to transmit, to an external electronic device, a frame including an uplink power headroom (UPH) control field, receive a trigger frame for uplink multi-user communication from the external electronic device, and perform communication with the external electronic device based on information included in the trigger frame, wherein the UPH control field indicates information about maximum power that the electronic device is capable of utilizing for communication, and wherein the information is determined based on a time average specific absorption rate (TAS) backoff policy.

In accordance with another aspect of the disclosure, an operating method of an access point (AP) is provided. The operating method of the electronic device includes transmitting, to an external electronic device, a frame including a UPH control field, receiving a trigger frame for uplink multi-user communication from the external electronic device, and performing communication with the external electronic device based on information included in the trigger frame, wherein the UPH control field indicates information about the maximum power that the electronic device is capable of utilizing for communication, and wherein the information is determined based on a TAS backoff policy.

In accordance with another aspect of the disclosure, an operating method of an access point (AP) is provided. The operating method includes receiving, from an electronic device connected to the AP, a time average specific absorption rate (TAS) entrustment request for entrusting an update of a TAS backoff policy, which is to be applied to the electronic device, to the AP, determining a TAS backoff restriction value of the electronic device based on a TAS parameter included in the TAS entrustment request and transmitting a trigger frame based on the TAS backoff restriction value to the electronic device, wherein the trigger frame is for uplink multi-user communication.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, from an electronic device connected to an access point (AP), a time average specific absorption rate (TAS) entrustment request for entrusting an update of a TAS backoff policy, which is to be applied to the electronic device, to the AP, determining a TAS backoff restriction value of the electronic device based on a TAS parameter comprised in the TAS entrustment request, and transmitting a trigger frame based on the TAS backoff restriction value to the electronic device, wherein the trigger frame is for uplink multi-user communication.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a wireless local area network (WLAN) system, according to an embodiment of the disclosure;

FIG. 2 illustrates another example of a WLAN system, according to an embodiment of the disclosure;

FIG. 3 is a diagram illustrating an example of a link setup operation, according to an embodiment of the disclosure;

FIGS. 4A and 4B are diagrams illustrating a specific absorption rate (SAR) backoff control method, according to various embodiments of the disclosure;

FIGS. 5A, 5B, and 5C are diagrams illustrating multi-user communication according to various embodiments of the disclosure;

FIG. 6 is an example of a schematic block diagram of an electronic device, according to an embodiment of the disclosure;

FIGS. 7A and 7B are diagrams illustrating a method of utilizing an uplink power headroom (UPH) control field, according to various embodiments of the disclosure;

FIGS. 8A and 8B are diagrams illustrating a method of entrusting an update of a TAS backoff policy to an access point (AP), according to various embodiments of the disclosure;

FIG. 9 is a flowchart illustrating an operating method of an electronic device, according to an embodiment of the disclosure;

FIG. 10 is a flowchart illustrating an operating method of an AP, according to an embodiment of the disclosure; and

FIG. 11 is a block diagram illustrating an electronic device in a network environment, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

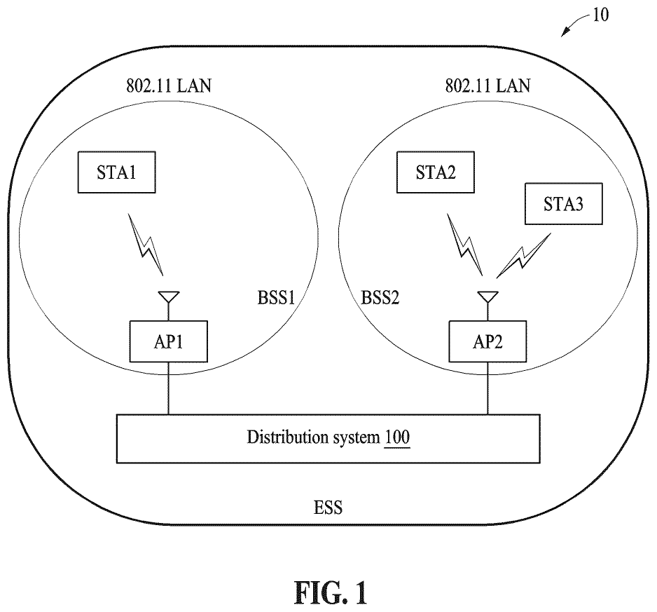

FIG. 1 illustrates an example of a wireless local area network (WLAN) system, according to an embodiment of the disclosure.

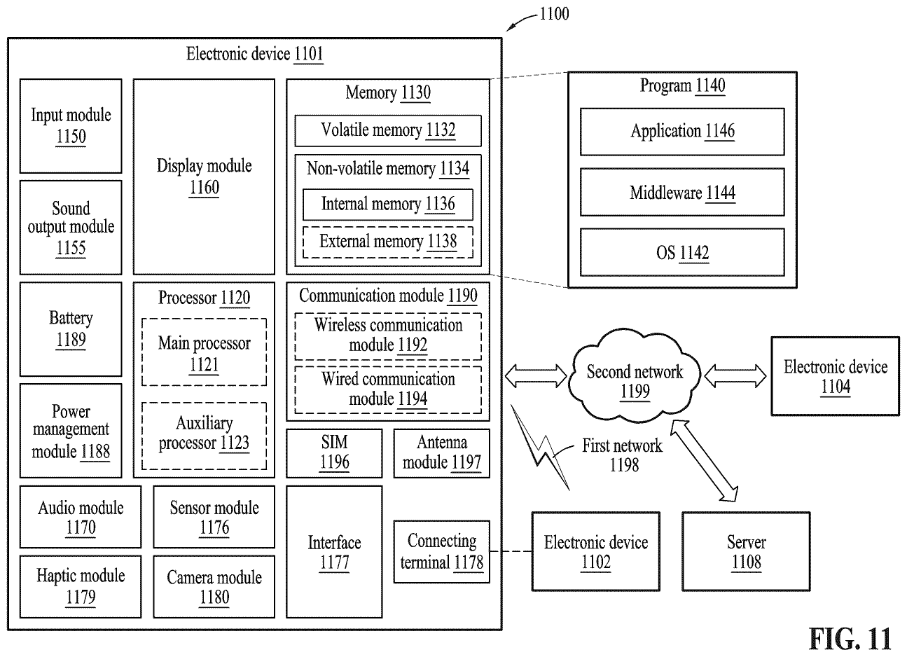

Referring to FIG. 1, according to an embodiment, a WLAN system 10 may refer to an infrastructure mode in which an access point (AP) is present in the structure of a WLAN of the Institute of Electrical and Electronics Engineers (IEEE) 802.11 standard. The WLAN system 10 may include one or more basic service sets (BSSs) (e.g., BSS1 and BSS2). The BSS (e.g., BSS1 or BSS2) may refer to a set of APs and stations (STAs) (e.g., an electronic device 1101, an electronic device 1102, and an electronic device 1104 of FIG. 11) that may communicate with each other with successful synchronization. The BSS1 may include an AP1 and an STA1, and the BSS2 may include an AP2, an STA2, and an STA3.

According to an embodiment, the WLAN system 10 may include at least one STA (e.g., STA1 to STA3), a plurality of APs (e.g., AP1 and AP2) providing a distribution service, and a distribution system 100 connecting the plurality of APs (e.g., AP1 and AP2). The distribution system 100 may implement an extended service set (ESS), which is a service set extended by connecting a plurality of BSSs (e.g., BSS1 and BSS2). The ESS may be used as a term referring to one network in which the plurality of APs (e.g., AP1 and AP2) is connected through the distribution system 100. The plurality of APs (e.g., AP1 and AP2) included in one ESS may have the same service set identification (SSID).

According to an embodiment, the STA (e.g., STA1 to STA3) may be an arbitrary functional medium including a medium access control (MAC) and a physical layer interface for a wireless medium that conform to the provisions of the IEEE 802.11 standard. The term “STA” (e.g., STA1 to STA3) may be used as including both an AP-STA and a non-AP STA. The STA (e.g., STA1 to STA3) may also be referred to by various names, such as an electronic device, a mobile terminal, a wireless device, a wireless transmit/receive unit (WTRU), user equipment (UE), a mobile station (MS), a mobile subscriber unit, or simply, a user.

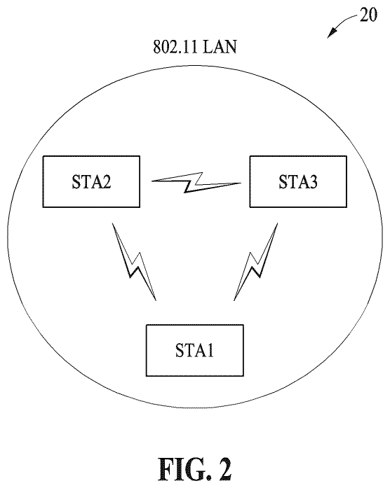

FIG. 2 illustrates an example of a WLAN system, according to an embodiment of the disclosure.

Referring to FIG. 2, according to an embodiment, a WLAN system 20 may refer to an ad-hoc mode in which a network is established and communicated between a plurality of STAs (e.g., STA1 to STA3) without any AP in a structure of a WLAN of the IEEE 802.11 standard, as opposed to the WLAN system 10 of FIG. 1. The WLAN system 20 may include a BSS operating in an ad-hoc mode, for example, an independent basic service set (IBSS).

According to an embodiment, since the IBSS does not include an AP, there may be no centralized management entity that performs a management function at the center. In the IBSS, the STAs may be managed in a distributed manner. In the IBSS, all the STAs may be mobile STAs and may form a self-contained network (or an integrated network) because access to a distribution system is not allowed.

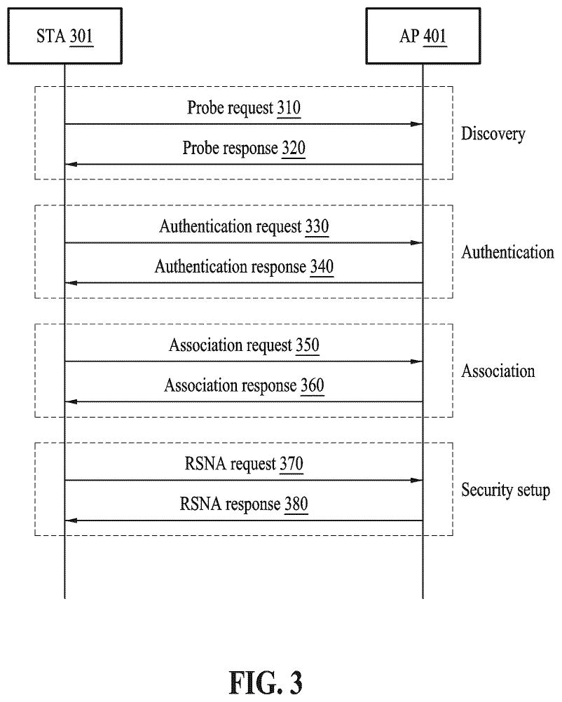

FIG. 3 is a diagram illustrating an example of a link setup operation, according to an embodiment of the disclosure.

Referring to FIG. 3, according to an embodiment, the link setup operation may be performed between devices (e.g., an STA 301 and an AP 401) to communicate with each other. For the link setup, operations for network discovery, execution of authentication, establishing association, and setting security may be performed. The link setup operation may be referred to as a session initiation operation or a session setup operation. Furthermore, the operations of discovery, authentication, association, and setting security of the link setup operation may be collectively referred to as an association operation.

According to an embodiment, a network discovery operation may include operations 310 and 320. In operation 310, the STA 301 (e.g., the electronic device 1101, the electronic device 1102, or the electronic device 1104 of FIG. 11) may transmit a probe request frame to probe which AP exists and may wait for a response to the probe request frame. The STA 301 may find a network to participate in by performing a scanning operation to access the network. The probe request frame may include information of the STA 301 (e.g., a device name and/or address of the STA 301). The scanning operation in operation 310 may refer to an active scanning operation. In operation 320, the AP 401 may transmit a probe response frame to the STA 301 that transmits the probe request frame, in response to the probe request frame. The probe response frame may include information of the AP 401 (e.g., a device name and/or network information of the AP 401). Although FIG. 3 shows that the network discovery operation is performed through active scanning, the disclosure is not necessarily limited thereto. When the STA 301 performs passive scanning, the operation of transmitting the probe request frame may be omitted. The STA 301 that performs passive scanning may receive a beacon frame transmitted by the AP 401 and perform the following subsequent procedures.

According to an embodiment, after the STA 301 discovers a network, an authentication operation including operations 330 and 340 may be performed. In operation 330, the STA 301 may transmit an authentication request frame to the AP 401. In operation 340, the AP 401 may determine whether to allow authentication for the STA 301 based on information included in the authentication request frame. The AP 401 may provide the STA 301 with a result of authentication processing through an authentication response frame. The authentication frame used for the authentication request and/or response may correspond to a management frame.

According to an embodiment, the authentication frame may include information on an authentication algorithm number, an authentication transaction sequence number, status code, challenge text, a robust security network (RSN), or a finite cyclic group.

According to an embodiment, after successful authentication of the STA 301, an association operation including operations 350 and 360 may be performed. In operation 350, the STA 301 may transmit an association request frame to the AP 401. In operation 360, the AP 401 may transmit an association response frame to the STA 301 in response to the association request frame.

According to an embodiment, the association request frame and/or the association response frame may include information related to various capabilities. For example, the association request frame may include information related to various capabilities, a beacon listening interval, an SSID, supported rates, supported channels, an RSN, a mobility domain, supported operating classes, a traffic indication map (TIM) broadcast request, and/or information related to an interworking service capability. For example, the association response frame may include information related to various capabilities, status code, association ID (AID), supported rates, an enhanced distributed channel access (EDCA) parameter set, a received channel power indicator (RCPI), a received signal-to-noise indicator (RSNI), a mobility domain, a timeout interval (e.g., an association comeback time), an overlapping BSS scan parameter, a TIM broadcast response, and/or information such as a quality of service (QoS) map.

According to an embodiment, after the STA 301 is successfully associated with the network, a security setup operation including operations 370 and 380 may be performed. The security setup operation may be performed through a robust security network association (RSNA) request/response. For example, the security setup operation may include an operation of performing private key setup by means of a 4-way handshaking through an extensible authentication protocol over local area network (LAN) (EAPOL) frame. The security setup operation may be performed according to a security scheme that is not defined in the IEEE 802.11 standard.

According to an embodiment, a security session may be established between the STA 301 and the AP 401 according to the security setup operation, and the STA 301 and the AP 401 may proceed with secure data communication.

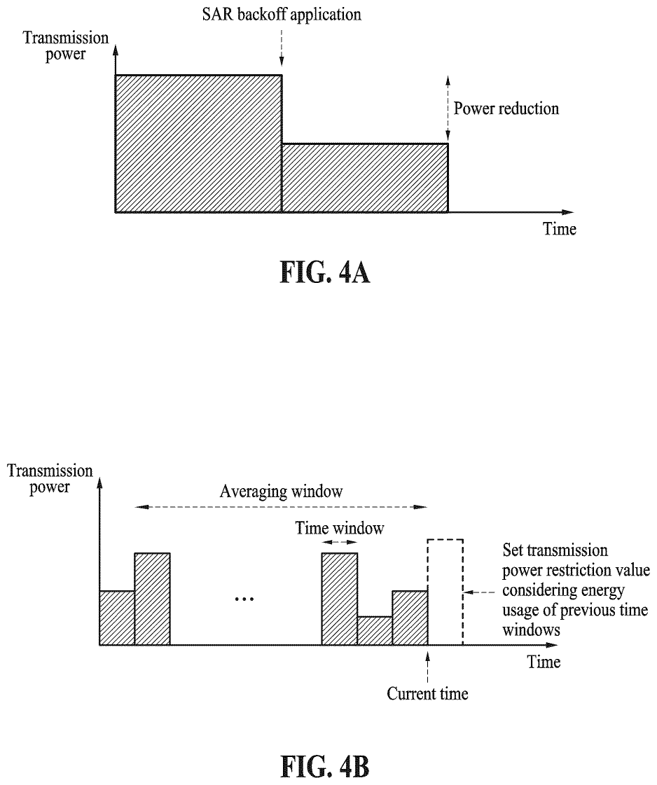

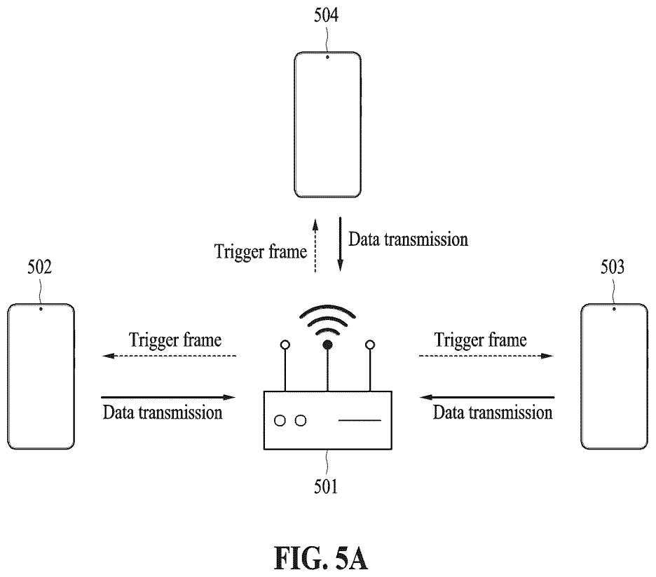

FIGS. 4A and 4B are diagrams illustrating a specific absorption rate (SAR) backoff control method, according to various embodiments of the disclosure.

According to an embodiment, wireless communication may be performed in such a manner that a transmitting end of an electronic device radiates electromagnetic waves into a wireless medium and a receiving end of an external device receives the radiated electromagnetic waves. When a person exists in a space in which electromagnetic waves are emitted and received, a significant amount of electromagnetic waves may be absorbed by the human body. Recent studies have reported that electromagnetic waves absorbed by the human body may have a number of adverse health effects. In particular, the absorption rate of electromagnetic waves rises sharply when the transmitting and receiving ends are close to the human body. Accordingly, most countries regulate the human body absorption rate of electromagnetic waves of smart devices. Since most smart devices use a WLAN, the WLAN is also subject to such regulations. Most countries have defined standards (e.g., regulations) for the SAR, which is the electromagnetic wave energy absorbed by the human body, and it is becoming mandatory for smart devices to satisfy the standards.

Referring to FIG. 4A, according to an embodiment, a SAR backoff control method performed to respond to regulations (e.g., SAR regulations) related to the human body absorption of electromagnetic waves may be identified. The SAR backoff control method (e.g., a SAR backoff policy) may be a method of controlling (e.g., restricting) the transmission power. According to the SAR backoff policy, a smart device may use high transmission power when it is determined that the human body is not in close proximity. In addition, the smart device may reduce the transmission power when it is determined that the human body is in close proximity.

According to an embodiment, the smart device may be equipped with various communication processors in addition to the WLAN. In a situation where a plurality of communication processors is operating simultaneously, the sum of electromagnetic wave energy radiated by each communication processor (e.g., an antenna associated with a communication processor) may be subject to regulations. Here, the smart device may reduce the transmission power output by each communication processor within the limits of the overall energy budget. As described above, the transmission power may be controlled to satisfy electromagnetic wave energy regulations (e.g., SAR regulations) absorbed by the human body. The SAR backoff control method described with reference to FIG. 4A may be a method of uniformly restricting the transmission power of all transmissions at a predetermined time (e.g., when the human body is close to a device). The effect of electromagnetic waves on the human body should be calculated in terms of the total amount of electromagnetic wave energy exposed over a predetermined time. The SAR backoff control method described with reference to FIG. 4A may have inefficiencies. For example, when transmission is rarely performed due to very little traffic at the previous time, the total amount of electromagnetic waves exposed to the human body may be insignificant, even when high transmission power is used at the current time. The user experience may deteriorate due to the transmission power restriction that does not need to be applied.

Referring to FIG. 4B, according to an embodiment, a SAR backoff control method (e.g., a time average specific absorption rate (TAS) backoff control method) performed to respond to regulations related to the human body absorption of electromagnetic waves may be identified. The TAS backoff control method (e.g., a TAS backoff policy) may be a method of restricting the transmission power in terms of the total amount of electromagnetic wave energy radiated during a predetermined window (e.g., an averaging window). The TAS backoff policy may restrict the average transmission power during an averaging window (e.g., 60 seconds or 100 seconds) to a predetermined value or less. The TAS backoff policy may update a TAS backoff restriction value in units of a time window that is much smaller than the averaging window, for satisfying the electromagnetic wave absorption rate regulations. The averaging window may be a time-rolling averaging window.

According to an embodiment, the TAS backoff control method may update the TAS backoff restriction value for each time window (or for each update interval) (e.g., a current time). The TAS backoff control method may control (e.g., restrict) the transmission power at the current time so that the average (e.g., average transmission power) obtained by dividing the energy usage used during the averaging window by the size of the averaging window satisfies the regulations. The TAS backoff control method may calculate the TAS backoff restriction value at the current time based on the sum of the energy usages (e.g., the product of the transmission time and the transmission power) of the previous time windows.

According to an embodiment, the TAS backoff control method may allocate an energy budget for each time window (e.g., an energy budget available in the current time window by considering the energy usage of previous time windows). The TAS backoff control method may calculate the TAS backoff restriction value (e.g., transmission power restriction) for the time window by dividing the energy budget allocated to the time window by the size of the time window. The TAS backoff control method may not unnecessarily restrict the transmission of the next time window even when no substantial transmission is performed during the previous time window that is set to allow transmission using high power (e.g., a transmission power restriction value is high).

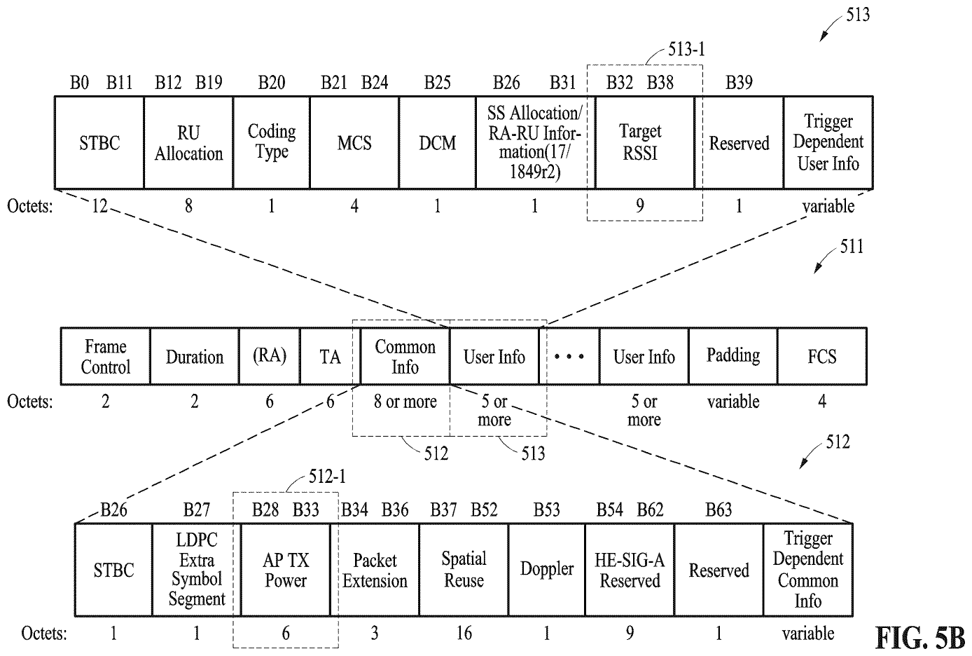

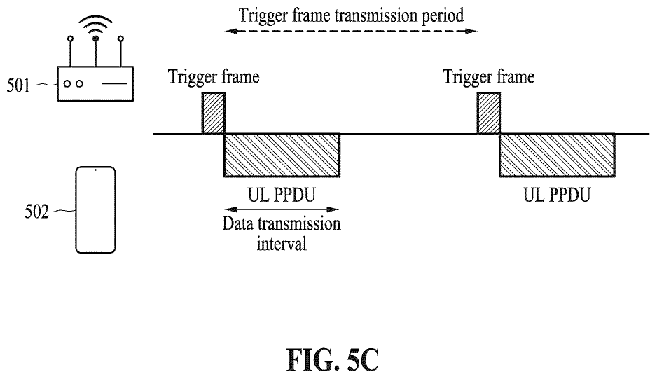

FIGS. 5A, 5B, and 5C are diagrams illustrating multi-user communication according to various embodiments of the disclosure.

Referring to FIG. 5A, an example of multi-user communication defined in the IEEE 802.11ax (e.g., wireless fidelity (Wi-Fi) 6) may be identified. Multi-user communication may refer to an AP 501 communicating with a plurality of STAs 502, 503, and 504 (e.g., multi-user). In multi-user communication, signals transmitted by the plurality of STAs 502, 503, and 504 to one AP 501 may need to be synchronized. To control the data transmission time of the STAs 502, 503, and 504, the AP 501 may first transmit a trigger frame to the STAs 502, 503, and 504. The STAs 502, 503, and 504 may start transmitting data after a promised delay time after receiving the trigger frame. That is, the trigger frame may be for triggering uplink multi-user communication.

In the case of multi-user communication, it may be difficult to accurately match the operating frequencies of the STAs 502, 503, and 504 that perform transmission at the same time. Accordingly, there may be a frequency offset between the signals transmitted by the STAs 502, 503, and 504. When the frequency offset exists, interference may occur between carriers of the signals. When interference occurs between carriers, a small signal may not be normally received by the AP 501 due to interference from a big signal. Accordingly, in multi-user communication, the sizes of the signals transmitted by the STAs 502, 503, and 504 may need to be controlled to be similar. Hereinafter, a method of controlling, by the AP 501, the sizes of the signals transmitted by the STAs 502, 503, and 504 to be similar is described with reference to FIG. 5B.

Referring to FIG. 5B, a format 511 of a trigger frame may be identified. A common info subfield 512 of the trigger frame may include an AP TX power subfield 512-1. A user info subfield 513 of the trigger frame may include a target received signal strength indicator (RSSI) subfield 513-1. The AP TX power subfield 512-1 may indicate a transmitted signal strength indicator (TSSI) of the trigger frame of the AP 501. The target RSSI subfield 513-1 may indicate a target RSSI of a data frame that an AP receives from the STAs (e.g., 502, 503, and 504).

The STAs (e.g., 502, 503, and 504) that receive the trigger frame may set their own transmission power based on the AP TX power subfield 512-1 and the target RSSI subfield 513-1 during multi-user communication. The STAs (e.g., 502, 503, and 504) that receive the trigger frame may set their own transmission power using Equation 1 below.

$$( {p}_{TX}^{AP} - RSSI ) + Target RSSI \qquad Equation 1$$

In Equation 1,

$${p}_{TX}^{AP}$$

denotes a TSSI of the trigger frame transmitted by the AP 501. RSSI denotes an RSSI of the trigger frame received by the STAs (e.g., 502, 503, and 504). Target RSSI denotes a target RSSI of the data frame that the AP receives from the STAs (e.g., 502, 503, and 504).

The STAs (e.g., 502, 503, and 504) may identify the degree of signal attenuation between an AP and an STA through a calculation of

$$( {p}_{TX}^{AP} - RSSI ) .$$

The STAs (e.g., 502, 503, and 504) may set, as the transmission power of the data frame, a value obtained by adding the target RSSI to the degree of signal attenuation between the AP and the STA. As a result, the RSSI of the data frame, which is transmitted by the STAs 502, 503, and 504 and received by the AP 501, may be constant.

Referring to FIG. 5C, the STAs (e.g., the STA 502) may need to set their own transmission power each time a data frame (e.g., an uplink physical layer convergence protocol data unit (UL PPDU)) is transmitted. That is, the STAs (e.g., the STA 502) may need to set their own transmission power for each transmission period (e.g., reception period) of the trigger frame.

However, as described with reference to FIGS. 4A and 4B, in the case of the STA 502 in which a TAS backoff policy is triggered to satisfy the SAR regulation, the transmission power restriction may exist (e.g., a TAS backoff restriction value exists) for a predetermined time (e.g., a time interval). Accordingly, the STA 502 in which the TAS backoff policy is triggered to satisfy the SAR regulation may not satisfy a target RSSI of the AP 501. As a result, since the size of the signal transmitted by the STA 502 is not sufficiently large, the signal may not be normally received by the AP 501. That is, this may be an issue that occurs because the AP 501 does not know the available transmission power of the STAs 502, 503, and 504 at the time of determining a target RSSI and an uplink scheduling interval (e.g., a trigger frame transmission period of the AP 501).

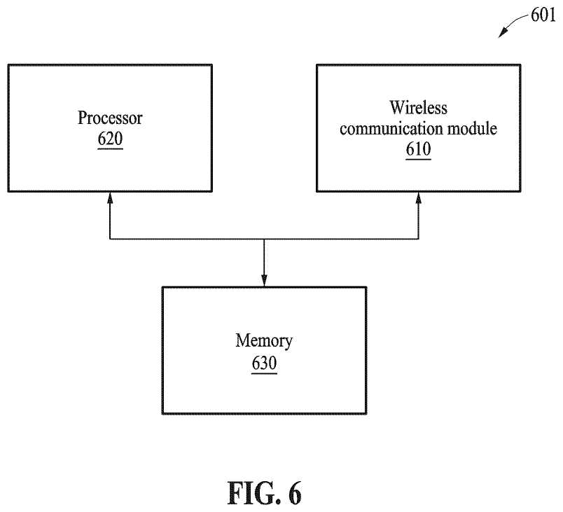

FIG. 6 is an example of a schematic block diagram of an electronic device, according to an embodiment of the disclosure.

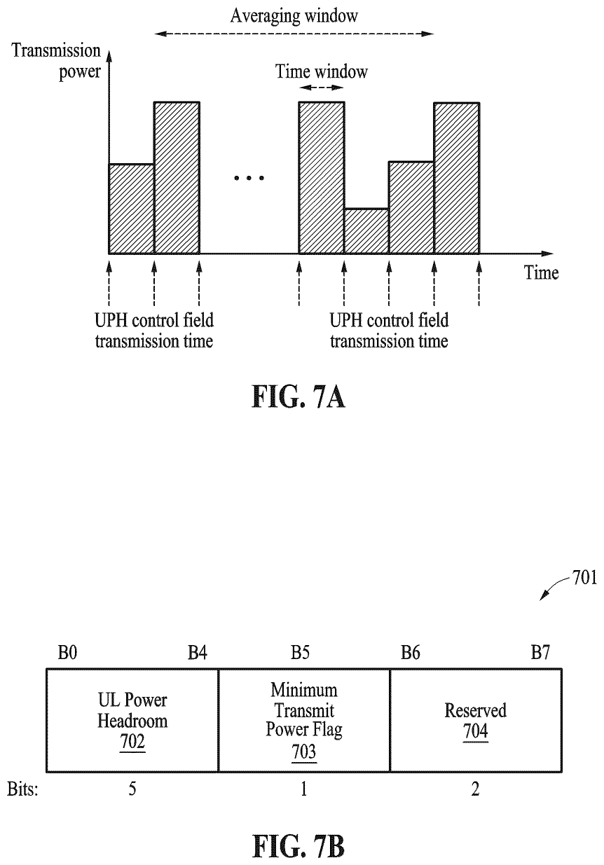

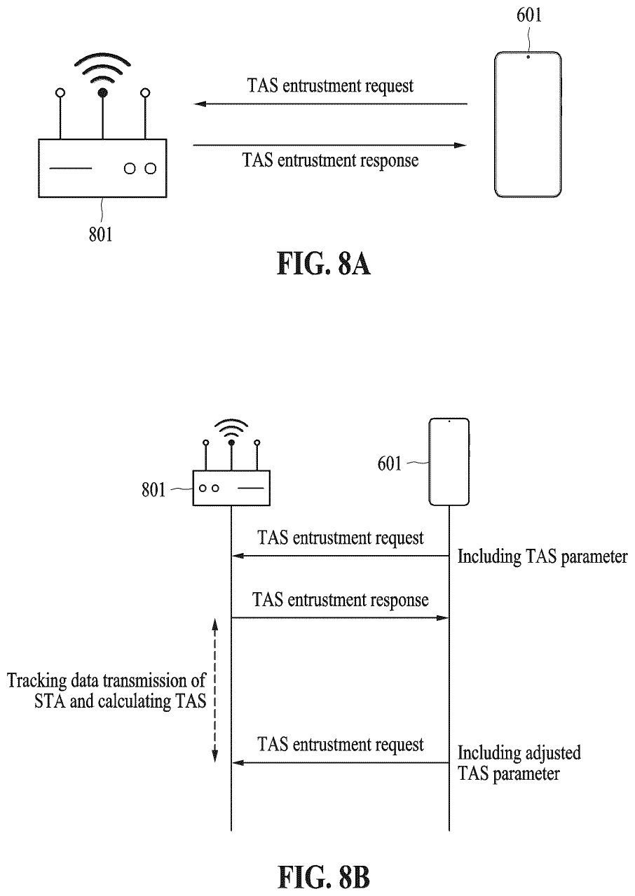

According to an embodiment, an electronic device (e.g., the STA 301 of FIG. 3, the electronic device 601 of FIG. 6, or an electronic device 1101 of FIG. 11) may be a combination of power control for satisfying an SAR regulation and power control for multi-user communication. An entity of power control for satisfying the SAR regulation may be an electronic device (e.g., an STA), and an entity (e.g., an entity of setting a target RSSI) of power control for uplink multi-user communication may be an AP. The electronic device 601 may control its own transmission power in conjunction with (e.g., by transmitting, to an AP, a TAS backoff policy for satisfying the SAR regulation) an AP (e.g., the AP 401 of FIG. 3, an AP 801 of FIG. 8A, or an electronic device 1104 of FIG. 11). This is described with reference to FIGS. 7A and 7B. Additionally, the electronic device 601 may allow the AP (e.g., the AP 401 of FIG. 3, an AP 801 of FIG. 8A, or an electronic device 1104 of FIG. 11) to control the TAS backoff policy (e.g., TAS entrustment negotiation). This is described with reference to FIGS. 8A and 8B.

Referring to FIG. 6, according to an embodiment, the electronic device 601 may include a wireless communication module 610 (e.g., a wireless communication module 1192 of FIG. 11), at least one processor 620 (e.g., a processor 1120 of FIG. 11), and memory 630 (e.g., memory 1130 of FIG. 11). The wireless communication module 610 may be configured to transmit and receive a wireless signal. The wireless communication module 610 may be a Wi-Fi chipset. The wireless communication module 610 may support multi-user communication. The processor 620 may be operatively connected to the wireless communication module 610. The memory 630 may be electrically connected to the processor 620 and store one or more instructions executable by the processor 620. The electronic device 601 may correspond to an electronic device (e.g., an electronic device 1101 of FIG. 11) to be described with reference to FIG. 11. Therefore, repeated descriptions to be provided with reference to FIG. 11 are omitted.

According to an embodiment, the processor 620 may be implemented as a system-on-chip (SoC) or circuitry (e.g., processing circuitry) such as an integrated circuit (IC). The processor 620 may include one or more processors. For example, the processor 620 may include a combination of one or more processors, such as a central processing unit (CPU), a graphics processing unit (GPU), a microprocessor unit (MPU), an application processor (AP), and a communication processor (CP).

According to an embodiment, the memory 630 may include one or more memories. The instructions stored in the memory 630 may be stored in one memory. The instructions stored in the memory 630 may be divided and stored in a plurality of memories. The instructions stored in the memory 630 may be executed by the processor 620 individually or collectively to cause the electronic device 601 to perform a backoff control method (e.g., an SAR backoff control method or a TAS backoff control method) according to an embodiment described herein.

According to an embodiment, the electronic device 601 may transmit a frame including an uplink power headroom (UPH) control field (e.g., a UPH control field 701 of FIG. 7B) to an external electronic device (e.g., the AP 401 of FIG. 3, an AP 801 of FIG. 8A, or an electronic device 1104 of FIG. 11). The electronic device 601 may receive a trigger frame for uplink multi-user communication from the external electronic device. The electronic device 601 may perform communication with the external electronic device based on information included in the trigger frame. The UPH control field may indicate information about the maximum power (e.g., the maximum transmission power) that the electronic device 601 may utilize for communication, in which the information may be determined based on the TAS backoff policy.

According to an embodiment, the electronic device 601 may enhance the user experience of multi-user communication by providing, to the AP, information about the TAS backoff policy for satisfying the SAR regulation or entrusting the operation of the TAS backoff policy to the AP.

FIGS. 7A and 7B are diagrams illustrating a method of utilizing a UPH control field, according to various embodiments of the disclosure.

Referring to FIG. 7A, according to an embodiment, an electronic device (e.g., the STA 301 of FIG. 3, the electronic device 601 of FIG. 6, or an electronic device 1101 of FIG. 11) may periodically transmit a frame including a UPH control field to an external electronic device (e.g., the AP 401 of FIG. 3, an AP 801 of FIG. 8A, or an electronic device 1104 of FIG. 11) at each update time of a TAS backoff restriction value. That is, the transmission time (transmission timing) of the frame including the UPH control field may be synchronized with the update time of the TAS backoff restriction value. The UPH control field may indicate information about the maximum power (e.g., the maximum transmission power) that the electronic device 601 may utilize for communication, in which the information may be determined based on the TAS backoff policy.

Referring to FIG. 7B, according to an embodiment, the UPH control field 701 may include a UPH subfield 702, a minimum transmit power flag subfield 703, and a reserved subfield 704. The UPH subfield 702 may indicate a value corresponding to the maximum power (e.g., the maximum transmission power). The minimum transmit power flag subfield 703 may indicate whether the electronic device 601 is currently using the minimum transmission power. The reserved subfield 704 may indicate whether the maximum power (e.g., the maximum transmission power) is determined based on the TAS backoff policy. By using one bit included in the reserved subfield 704 in association with the TAS backoff policy, the external electronic device (e.g., the AP 401 of FIG. 3, an AP 801 of FIG. 8A, or an electronic device 1104 of FIG. 11) may receive help in determining an uplink scheduling interval.

According to an embodiment, the external electronic device (e.g., the AP 401 of FIG. 3, an AP 801 of FIG. 8A, or an electronic device 1104 of FIG. 11) may determine an uplink scheduling interval (e.g., corresponding to a trigger frame transmission period of the external electronic device) and a target RSSI of electronic devices (e.g., the electronic device 601), based on information included in the UPH control field.

According to an embodiment, the external electronic device may determine the target RSSI by considering all of the maximum transmission power of the electronic devices (e.g., STAs) connected to the external electronic device (e.g., an AP). When at least one (e.g., the electronic device 601) of the electronic devices may not satisfy the target RSSI required by the external electronic device (e.g., a limit on the maximum transmission power), the external electronic device may reduce the uplink scheduling interval (e.g., a trigger frame transmission period). That is, by reducing the data frame transmission time of the electronic devices (e.g., the electronic device 601), the transmission power of the electronic devices (e.g., the electronic device 601) may increase. For example, by reducing the uplink scheduling interval by 50%, the transmission power of the electronic devices (e.g., the electronic device 601) may be doubled. The external electronic device may determine the target RSSI to be a desired value based on the doubled transmission power of the electronic devices (e.g., the electronic device 601). The above description may assume that all electronic devices connected to the external electronic device provide information related to the TAS backoff policy. It is not necessary for all electronic devices connected to the external electronic device to provide the information related to the TAS backoff policy through the UPH control field, and the external electronic device may determine the target RSSI and uplink scheduling interval by considering only the received information.

According to an embodiment, the external electronic device may generate a trigger frame for uplink multi-user communication based on the determined uplink scheduling interval and target RSSI. The trigger frame may include an uplink scheduling interval, a target RSSI of the electronic devices (e.g., the electronic device 601), and/or a TSSI of the trigger frame. The external electronic device may transmit the trigger frame to the electronic devices (e.g., the electronic device 601).

According to an embodiment, the electronic device 601 that receives the trigger frame may communicate with the external electronic device based on information included in the trigger frame. The electronic device 601 may set the transmission power of the electronic device 601 based on a TSSI of the trigger frame, an RSSI of the trigger frame, and a target RSSI of the electronic device 601 (e.g., see FIG. 5B). The electronic device 601 may perform communication with the external electronic device based on the set transmission power. The set transmission power may be less than or equal to the maximum power (e.g., the maximum power that the electronic device 601 may utilize for communication during one time window).

According to an embodiment, the electronic device 601 may enhance the user experience of multi-user communication by providing, to the AP, information about the TAS backoff policy for satisfying the SAR regulation.

FIGS. 8A and 8B are diagrams illustrating a method of entrusting an update of a TAS backoff policy to an AP, according to various embodiments of the disclosure.

According to an embodiment, an AP 801 (e.g., the AP 401 of FIG. 3 or an electronic device 1104 of FIG. 11) may track a data transmission-related history of the electronic device 601 (e.g., the STA 301 of FIG. 3 or an electronic device 1101 of FIG. 11) connected to the AP 801. The AP 801 may directly calculate a TAS backoff restriction value (e.g., a transmission power restriction value) based on the data transmission-related history of the electronic device 601. The AP 801 may generate a trigger frame based on the TAS backoff restriction value of the electronic device 601, which is directly calculated.

Referring to FIG. 8A, according to an embodiment, the AP 801 may receive a TAS entrustment request from the electronic device 601. The TAS entrustment request may be for entrusting an update of a TAS backoff policy, which is to be applied to the electronic device 601, to an AP. In response to receiving the TAS entrustment request, the AP 801 may transmit a TAS entrustment response to the electronic device 601. According to the exchange of the TAS entrustment request and TAS entrustment response, an operational entity of the TAS backoff policy of the electronic device 601 may be entrusted to the AP 801.

Referring to FIG. 8B, according to an embodiment, the TAS entrustment request may include a TAS parameter. The TAS parameter may include information about an averaging window, information about a time window, and/or an energy budget available in a current time window. The AP 801 may determine the TAS backoff restriction value of the electronic device 601 based on the TAS parameter. The description of the determination of the averaging window, time window, energy budget, and TAS backoff restriction value is provided with reference to FIG. 4B, and thus, a repeated description thereof is omitted.

According to an embodiment, the AP 801 may determine an uplink scheduling interval and a target RSSI of electronic devices (e.g., the electronic device 601) based on the TAS backoff restriction value. Not all electronic devices connected to the AP 801 may need to request TAS entrustment to the AP 801, and the AP 801 may only consider the TAS backoff restriction value of the electronic device (e.g., 601) that requests TAS entrustment.

According to an embodiment, the AP 801 may generate a trigger frame including an uplink scheduling interval, a target RSSI of the electronic devices (e.g., the electronic device 601), and/or a TSSI of the trigger frame. The trigger frame may be for uplink multi-user communication. The AP 801 may transmit the trigger frame to the electronic devices (e.g., the electronic device 601). The electronic device 601 may perform communication with the AP 801 based on information included in the trigger frame.

According to an embodiment, the AP 801 entrusted with the operation of the TAS backoff policy may track the data transmission power and data transmission time of the electronic device 601. The AP 801 may periodically transmit, to the electronic device 601, the trigger frame based on the data transmission power and data transmission time. An operation of generating the trigger frame is substantially the same as the operation described above, and thus, a repeated description thereof is omitted.

According to an embodiment, when the TAS parameter is adjusted, the electronic device 601 may transmit, to the AP 801, a TAS entrustment request including the adjusted TAS parameter. The TAS entrustment request may be torn down by the electronic device 601 when the TAS backoff policy does not need to be applied to the electronic device 601 (e.g., when the user's body moves away from the electronic device 601).

According to an embodiment, the electronic device 601 may enhance the user experience of multi-user communication by entrusting the operation of the TAS backoff policy to the AP 801.

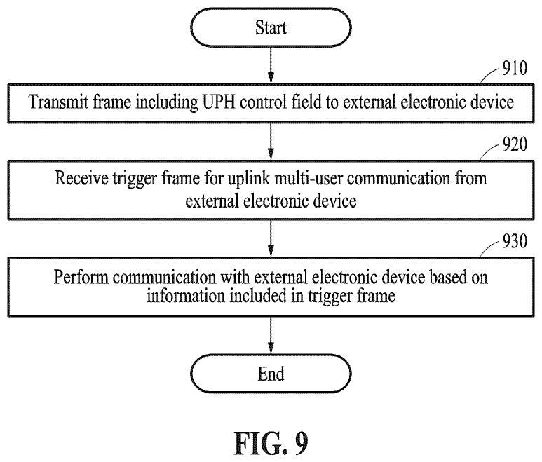

FIG. 9 is a flowchart illustrating an operating method of an electronic device, according to an embodiment of the disclosure.

Referring to FIG. 9, according to an embodiment, operations 910 to 930 may be performed sequentially but not necessarily. For example, the order of operations 910 to 930 may be changed, and at least two of operations 910 to 930 may be performed in parallel.

According to an embodiment, in operation 910, an electronic device (e.g., the STA 301 of FIG. 3, the electronic device 601 of FIG. 6, or an electronic device 1101 of FIG. 11) may transmit a frame including a UPH control field to an external electronic device (e.g., the AP 401 of FIG. 3, the AP 801 of FIG. 8A, or an electronic device 1104 of FIG. 11).

According to an embodiment, in operation 920, the electronic device may receive a trigger frame for uplink multi-user communication from the external electronic device.

According to an embodiment, in operation 930, the electronic device may perform communication with the external electronic device based on information included in the trigger frame. The UPH control field may indicate information about the maximum power that the electronic device may utilize for communication, in which the information may be determined based on a TAS backoff policy.

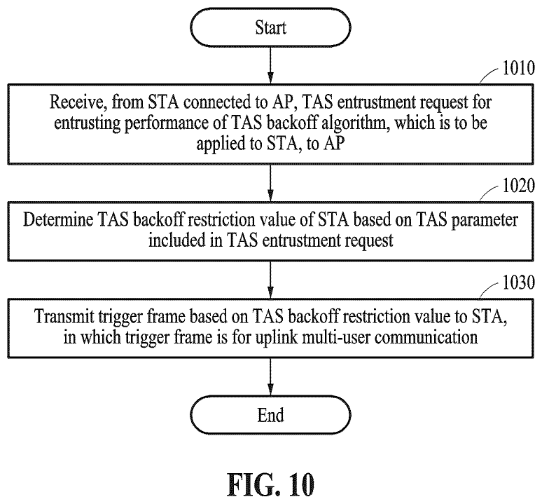

FIG. 10 is a flowchart illustrating an operating method of an AP, according to an embodiment of the disclosure.

Referring to FIG. 10, according to an embodiment, operations 1010 to 1030 may be performed sequentially but not necessarily. For example, the order of operations 1010 to 1030 may be changed, and at least two of operations 1010 to 1030 may be performed in parallel.

According to an embodiment, in operation 1010, an AP (e.g., the AP 401 of FIG. 3, the AP 801 of FIG. 8A, or an electronic device 1104 of FIG. 11) may receive, from an electronic device (e.g., the STA 301 of FIG. 3, the electronic device 601 of FIG. 6, or an electronic device 1101 of FIG. 11) connected to the AP, a TAS entrustment request for entrusting an update of a TAS backoff policy, which is to be applied to an electronic device, to the AP.

According to an embodiment, in operation 1020, the AP may determine a TAS backoff restriction value of the electronic device based on a TAS parameter included in the TAS entrustment request.

According to an embodiment, in operation 1030, the AP may transmit a trigger frame based on the TAS backoff restriction value to the electronic device, in which the trigger frame may be for uplink multi-user communication.

FIG. 11 is a block diagram illustrating an electronic device in a network environment, according to an embodiment of the disclosure.

Referring to FIG. 11, the electronic device 1101 in a network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments, at least one of the components (e.g., the connecting terminal 1178) may be omitted from the electronic device 1101, or one or more other components may be added to the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to an embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a CPU or an AP), or an auxiliary processor 1123 (e.g., a GPU, a neural processing unit (NPU), an image signal processor (ISP), a sensor hub processor, or a CP) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an ISP or a CP) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150 or output the sound via the sound output module 1155 or an external electronic device (e.g., the electronic device 1102) (e.g., a speaker or headphone) directly or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

The connecting terminal 1178 may include a connector via which the electronic device 1101 may be physically connected with the external electronic device (e.g., the electronic device 1102). According to an embodiment, the connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, ISPs, or flashes.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more CPs that are operable independently from the processor 1120 (e.g., the AP) and support a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device 1104 via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the millimeter wave (mmWave) band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to an embodiment, the antenna module 1197 may form a mm Wave antenna module. According to an embodiment, the mm Wave antenna module may include a PCB, a RFIC disposed on a first surface (e.g., the bottom surface) of the PCB, or adjacent to the first surface and capable of supporting a designated high-frequency band (e.g., the mmWave band), and a plurality of antennas (e.g., array antennas) disposed on a second surface (e.g., the top or a side surface) of the PCB, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102 or 1104, or server 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an Internet-of-Things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a complier or code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

An electronic device (e.g., the STA 301 of FIG. 3, the electronic device 601 of FIG. 6, or the electronic device 1101 of FIG. 11), according to an embodiment, may include at least one wireless communication module (e.g., the wireless communication module 610 of FIG. 6 or the wireless communication module 1192 of FIG. 11) configured to transmit and receive a wireless signal, at least one processor (e.g., the processor 620 of FIG. 6 or the processor 1120 of FIG. 11) operatively connected to the wireless communication module, and memory (e.g., the memory 630 of FIG. 6 or the memory 1130 of FIG. 11) storing instructions. The instructions, when executed by the processor 120 or 1120 individually or collectively, may cause the electronic device 301, 601, or 1101 to transmit, to an external electronic device (e.g., the AP 401 of FIG. 3, the AP 801 of FIG. 8A, or the electronic device 1104 of FIG. 11), a frame including a UPH control field (e.g., the UPH control field 701 of FIG. 7B). The instructions, when executed by the processor 120 or 1120 individually or collectively, may cause the electronic device 301, 601, or 1101 to receive a trigger frame for uplink multi-user communication from the external electronic device. The instructions, when executed by the processor 120 or 1120 individually or collectively, may cause the electronic device 301, 601, or 1101 to perform communication with the external electronic device based on information included in the trigger frame. The UPH control field may indicate information about the maximum power that the electronic device may utilize for communication, in which the information may be determined based on a TAS backoff policy.

According to an embodiment, the UPH control field may include a UPH subfield (e.g., the UPH subfield 702 of FIG. 7B) indicating a value corresponding to the maximum power. The UPH control field may include a reserved subfield (e.g., the reserved subfield 704 of FIG. 7B) indicating whether the maximum power is determined based on the TAS backoff policy.

According to an embodiment, the TAS backoff policy may be based on an SAR regulation to limit human body absorption of electromagnetic waves generated by the electronic device.

According to an embodiment, the TAS backoff policy may be configured to update a TAS backoff restriction value for each time window to restrict average transmission power of the electronic device to a predetermined value or less during an averaging window.

According to an embodiment, a transmission time of the frame may be synchronized with an update time of the TAS backoff restriction value according to the TAS backoff policy.

According to an embodiment, the frame may be periodically transmitted at each update time of the TAS backoff restriction value according to the TAS backoff policy.

According to an embodiment, the external electronic device may be configured to determine an uplink scheduling interval and a target RSSI of the electronic device based on information included in the UPH control field.

According to an embodiment, the information included in the trigger frame may include at least one of an uplink scheduling interval, a target RSSI of the electronic device, or a TSSI of the trigger frame.

According to an embodiment, the instructions, when executed by the processor 120 or 1120 individually or collectively, may cause the electronic device 301, 601, or 1101 to set transmission power of the electronic device based on a TSSI of the trigger frame, an RSSI of the trigger frame, and a target RSSI of the electronic device. The instructions, when executed by the processor 120 or 1120 individually or collectively, may cause the electronic device 301, 601, or 1101 to perform communication with the external electronic device based on the transmission power.

According to an embodiment, the transmission power may be less than or equal to the maximum power.

According to an embodiment, an operating method of an AP (e.g., the AP 401 of FIG. 3, the AP 801 of FIG. 8A, or the electronic device 1104 of FIG. 11) may include receiving, from an electronic device (e.g., the STA 301 of FIG. 3, the electronic device 601 of FIG. 6, or the electronic device 1101 of FIG. 11) connected to the AP, a TAS entrustment request for entrusting an update of a TAS backoff policy, which is to be applied to the electronic device, to the AP. The operating method of the AP may include determining a TAS backoff restriction value of the electronic device based on a TAS parameter included in the TAS entrustment request. The operating method of the AP may include transmitting a trigger frame based on the TAS backoff restriction value to the electronic device, in which the trigger frame may be for uplink multi-user communication.

According to an embodiment, the TAS backoff policy may be based on an SAR regulation to limit human body absorption of electromagnetic waves generated by the electronic device.

According to an embodiment, the TAS backoff policy may be configured to update the TAS backoff restriction value for each time window to restrict average transmission power of the electronic device to a predetermined value or less during an averaging window.

According to an embodiment, the TAS parameter may include at least one of information about an averaging window, information about a time window, or an energy budget available in a current time window.

According to an embodiment, the operating method of the AP may further include determining an uplink scheduling interval and a target RSSI of the electronic device based on the TAS backoff restriction value. The uplink scheduling interval and the target RSSI of the electronic device may be included in the trigger frame.

According to an embodiment, the uplink scheduling interval may correspond to a trigger frame transmission period of the AP.

According to an embodiment, the TAS entrustment request may be torn down by the electronic device when the TAS backoff policy does not need to be applied to the electronic device.

According to an embodiment, when the TAS parameter is adjusted, the electronic device may be configured to transmit, to the AP, the TAS entrustment request including the adjusted TAS parameter.

According to an embodiment, the operating method of the AP may further include transmitting a TAS entrustment response to the electronic device in response to receiving the TAS entrustment request.

According to an embodiment, the operating method of the AP may further include tracking data transmission power and data transmission time of the electronic device. The operating method of the AP may further include periodically transmitting a trigger frame based on the data transmission power and the data transmission time to the electronic device.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one wireless communication module configured to transmit and receive a wireless signal;
at least one processor operatively connected to the wireless communication module; and
memory storing instructions,
wherein the instructions, when executed by the at least one processor individually or collectively, cause the electronic device to:
transmit, to an external electronic device, a frame comprising an uplink power headroom (UPH) control field,
receive a trigger frame for uplink multi-user communication from the external electronic device, and
perform communication with the external electronic device based on information comprised in the trigger frame,
wherein the UPH control field indicates information about maximum power that the electronic device is capable of utilizing for communication, and
wherein the information is determined based on a time average specific absorption rate (TAS) backoff policy.

2. The electronic device of claim 1, wherein the UPH control field comprises:
a UPH subfield indicating a value corresponding to the maximum power; and
a reserved subfield indicating whether the maximum power is determined based on the TAS backoff policy.

3. The electronic device of claim 1, wherein the TAS backoff policy is based on a specific absorption rate (SAR) regulation to limit human body absorption of electromagnetic waves generated by the electronic device.

4. The electronic device of claim 1, wherein the TAS backoff policy is configured to update a TAS backoff restriction value for each time window to restrict average transmission power of the electronic device to a predetermined value or less during an averaging window.

5. The electronic device of claim 4, wherein a transmission time of the frame is synchronized with an update time of the TAS backoff restriction value according to the TAS backoff policy.

6. The electronic device of claim 5, wherein the frame is periodically transmitted at each update time of the TAS backoff restriction value according to the TAS backoff policy.

7. The electronic device of claim 1, wherein the external electronic device is configured to determine an uplink scheduling interval and a target received signal strength indicator (RSSI) of the electronic device, based on information comprised in the UPH control field.

8. The electronic device of claim 1, wherein the information comprised in the trigger frame comprises at least one of an uplink scheduling interval, a target received signal strength indicator (RSSI) of the electronic device, or a transmitted signal strength indicator (TSSI) of the trigger frame.

9. The electronic device of claim 1, wherein the instructions, when executed by the processor individually or collectively, cause the electronic device to:
set a transmission power of the electronic device based on a transmitted signal strength indicator (TSSI) of the trigger frame, a received signal strength indicator (RSSI) of the trigger frame, and a target RSSI of the electronic device; and
perform communication with the external electronic device based on the transmission power.

10. The electronic device of claim 9, wherein the transmission power is less than or equal to the maximum power.

11. An operating method of an access point (AP), the operating method comprising:
receiving, from an electronic device connected to the AP, a time average specific absorption rate (TAS) entrustment request for entrusting an update of a TAS backoff policy, which is to be applied to the electronic device, to the AP;
determining a TAS backoff restriction value of the electronic device based on a TAS parameter comprised in the TAS entrustment request; and
transmitting a trigger frame based on the TAS backoff restriction value to the electronic device, wherein the trigger frame is for uplink multi-user communication.

12. The operating method of claim 11, wherein the TAS backoff policy is based on a specific absorption rate (SAR) regulation to limit human body absorption of electromagnetic waves generated by the electronic device.

13. The operating method of claim 11, wherein the TAS backoff policy is configured to update the TAS backoff restriction value for each time window to restrict average transmission power of the electronic device to a predetermined value or less during an averaging window.

14. The operating method of claim 11, wherein the TAS parameter comprises at least one of information about an averaging window, information about a time window, or an energy budget available in a current time window.

15. The operating method of claim 11, further comprising determining an uplink scheduling interval and a target received signal strength indicator (RSSI) of the electronic device, based on the TAS backoff restriction value,
wherein the uplink scheduling interval and the target RSSI of the electronic device are comprised in the trigger frame.

16. One or more non-transitory computer-readable storage media storing one or more computer programs including computer-executable instructions that, when executed by one or more processors of an electronic device individually or collectively, cause the electronic device to perform operations, the operations comprising:
receiving, from an electronic device connected to an access point (AP), a time average specific absorption rate (TAS) entrustment request for entrusting an update of a TAS backoff policy, which is to be applied to the electronic device, to the AP;
determining a TAS backoff restriction value of the electronic device based on a TAS parameter comprised in the TAS entrustment request; and
transmitting a trigger frame based on the TAS backoff restriction value to the electronic device, wherein the trigger frame is for uplink multi-user communication.

17. The one or more non-transitory computer-readable storage media of claim 16, wherein the TAS backoff policy is based on a specific absorption rate (SAR) regulation to limit human body absorption of electromagnetic waves generated by the electronic device.

18. The one or more non-transitory computer-readable storage media of claim 16, wherein the TAS backoff policy is configured to update the TAS backoff restriction value for each time window to restrict average transmission power of the electronic device to a predetermined value or less during an averaging window.

19. The one or more non-transitory computer-readable storage media of claim 16, wherein the TAS parameter comprises at least one of information about an averaging window, information about a time window, or an energy budget available in a current time window.

20. The one or more non-transitory computer-readable storage media of claim 16, the operations further comprising:
determining an uplink scheduling interval and a target received signal strength indicator (RSSI) of the electronic device, based on the TAS backoff restriction value,
wherein the uplink scheduling interval and the target RSSI of the electronic device are comprised in the trigger frame.
